(19) United States
(12) Patent Application Publication
(10) Pub. No.: US 2015/0137683 A1
(43) Pub. Date: May 21, 2015

(54) LED LAMPS AND CONTROLLERS FOR LIGHTING FIXTURES

(71) Applicant: SORAA, INC., FREMONT, CA (US)

(72) Inventors: Michael Ragan Krames, MOUNTAIN VIEW, CA (US); WILFRED A. MARTIS, SAN FRANCISCO, CA (US); FRANK SHUM, SUNNYVALE, CA (US); RONALD RANDALL VAN THIEL, FREMONT, CA (US)

(21) Appl. No.: 14/569,308

(22) Filed: Dec. 12, 2014

Related U.S. Application Data
(63) Continuation-in-part of application No. 14/098,244, filed on Dec. 5, 2013.
Application No. 14/098,244 is a continuation-in-part of application No. 13/915,432, filed on Jun. 11, 2013.
Application No. 13/915,432 is a continuation-in-part of application No. 29/492,740, filed on Jun. 2, 2014.
Application No. 29/492,740 is a continuation-in-part of application No. 29/492,704, filed on Jun. 2, 2014.
(60) Provisional application No. 61/912,348, filed on Dec. 5, 2013.
(60) Provisional application No. 61/659,386, filed on Jun. 13, 2012.

(51) Int. Cl. F21V 29/70; H05B 33/08

(52) U.S. Cl. CPC F21V 29/70; H05B 33/0845
USPC 315/113; 315/294

(57) ABSTRACT

LED lighting systems including mated components such that the LED light source component is separated from the LED controller by a distance and/or by a temperature differential are disclosed.

This application is a continuation-in-part application of U.S. application Ser. No. 14/098,244, filed on Dec. 5, 2013, which claims the benefit under 35 U.S.C. §119(e) of U.S. Provisional Application No. 61/912,348 filed on Dec. 5, 2013, and which is a continuation-in-part application of U.S. application Ser. No. 13/915,432, filed on Jun. 11, 2013, which claims the benefit under 35 U.S.C. §119(e) of U.S. Provisional Application No. 61/659,386, filed on Jun. 13, 2012; and this application is a continuation-in-part of U.S. Design Application No. 29/492,740 filed on Jun. 2, 2014; and this application is a continuation-in-part of U.S. Design Application No. 29/492,704, filed on Jun. 2, 2014, each of which is incorporated by reference in its entirety.

### FIELD

The disclosure relates to lighting systems and more particularly to light emitting diode (LED) lamps and controllers for use in such lighting systems.

### BACKGROUND

In the past, lighting fixture manufacturers have designed their products around a set of standard conventional light sources, or lamps. This allowed the fixture manufacturers to focus on design, optics (secondary and tertiary), and controls, and leave the light generation aspects in the hands of lamp manufacturers. In the emerging solid-state lighting era, this strategy is not so straightforward to implement. LED-based retrofit lamps are not simple resistive loads (like a tungsten filament) but incorporate their own driver circuits to condition the input signal (e.g., mains or low-voltage) for driving the LEDs within the lamp. Furthermore, the retrofit LED lamp drivers/controllers are constrained by space (e.g., ANSI form factors), heat (close proximity to LEDs), and cost, and typically do not include all the features that a lighting fixture manufacturer may desire in a luminaire product. Such features could include, for example, “flicker-free” operation, ultra-low dimming capability, demand response, etc. This means additional controls need to be added at the fixture level, however, these controls must also be compatible with the retrofit LED lamp drivers, which is not always possible in the absence of the herein-disclosed techniques. For example, a constant-power retrofit lamp driver will compete with a primary driver that is trying to dim the LED lamp. Also, from a fixture point of view, the overall system is non-optimum since the total driver bill of materials (BOM) is unnecessarily high (i.e., expensive) and cascading driver losses reduce overall luminaire efficiency.

One legacy solution to this problem is for lighting fixture manufacturers to work directly with component LEDs providers. However, this requires a manufacture to deal with various LED vendors, coordinate characteristics binning, and address thermal management solutions for which they have no core competency. Also, each luminaire requires its own specific design (e.g., pertaining to brightness, beam angle, lifetime target, etc.) resulting in a non-scalable business model.

An improved solution is to design fixtures based on a selection of pre-mated LED components, and arrange the pre-mated components to form a complete system. Inasmuch as the design of effective thermal management solutions for high-performance LEDs often highlights the criticality of mating a specific LED light source component with a compatible heat dissipation solution, there is a need for improved approaches.

The herein-disclosed pre-mated LED components in the form of light engines and light modules address the problems to be solved.

### SUMMARY

In a first aspect, light emitting diode (LED) lighting systems are provided comprising: at least one controller; and at least one LED lamp coupled to the at least one controller, wherein the at least one LED lamp comprises at least one LED, wherein the at least one LED is operated at a junction temperature that is at least 15° C. higher than a temperature of the controller.

In a second aspect, light emitting diode (LED) lighting systems are provided comprising: an integrated LED lamp comprising a housing, an LED, a primary optic, and a heatsink; and a controller electrically coupled to the LED and separated by at least 3 inches from the integrated LED lamp.

In a third aspect, light emitting diode (LED) lighting infrastructures are provided comprising one or more LED lighting systems, wherein each of the one or more LED lighting systems comprises: a controller; and a plurality of integrated LED lamps, wherein each of the LED lamps comprises LED electrically coupled to the controller.

In a fourth aspect, light emitting diode (LED) lighting infrastructures are provided comprising a plurality of LED lighting systems, wherein each of the plurality of LED lighting systems comprises: one or more integrated LED lamps, wherein each of the one or more LED lamps comprises a housing, an LED, a primary optic, and a heatsink; and a controller module logically coupled to each of the one or more LEDs; the controller module being separated by a distance of at least 3 inches from the housing.

In a fifth aspect, an LED (e.g., LED array, light chip, etc.) is selected based at least in part on retrofit specifications, and a driver/controller is selected based at least in part on the selected LED, wherein the driver/controller is disposed distally (e.g., at least 3 inches) from the LED. In some cases the driver/controller is selected based at least in part on an operating junction temperature of the selected LED, wherein the driver/controller is disposed distally so as to operate at least 15° C. lower than a temperature of the junction temperature of the selected LED.

In a sixth aspect, an LED housing with an integrated LED light source component (e.g., LED array, light chip, etc.) is selected based at least in part on luminaire design specifications, and a heatsink with an integrated driver/controller is selected based at least in part on the selected LED light source. In the disclosed combinations, the driver/controller is disposed distally from the LED light source so as to operate at least 15° C. lower than a temperature of the junction temperature of the selected LED light source.

### BRIEF DESCRIPTION OF THE DRAWINGS

Those skilled in the art will understand that the drawings, described herein, are for illustration purposes only. The drawings are not intended to limit the scope of the present disclosure.

FIG. 1A shows an example of a retrofit lamp fixture.

FIG. 1B shows an example of a deadhead lamp fixture, according to certain embodiments.

FIG. 2 is a comparison graph showing roadmap improvements in the 24-degree MR16 center-beam candle-power (CBCP) for LED lamps for directional lighting fixtures, according to certain embodiments.

FIG. 3 is a diagram of a lighting fixture showing improvements for LED lamps for lighting fixtures, according to certain embodiments.

FIG. 4 is a diagram of a lighting system showing a multiple head arrangement using a single driver module distally disposed from lighting heads, according to certain embodiments.

FIG. 5 is a diagram of a lighting infrastructure with multiple heads having LED lamps and a single driver operating the multiple heads, according to certain embodiments.

FIG. 6A depicts a selection of LED light source components including an LED, a heatsink, and a driver/controller, according to certain embodiments.

FIG. 6B shows an integrated housing in juxtaposition with a distally-located driver module, according to certain embodiments.

FIG. 6C-1 and FIG. 6C-2 are diagrams showing an LED lamp in a retrofit form factor suited for use in the integrated housing and distally-located driver module of FIG. 6B, according to certain embodiments.

FIGS. 7A through 7I depict embodiments of the present disclosure in the form of lamp applications.

FIG. 8 depicts a block diagram of a system to perform certain method steps for building a light emitting diode (LED) lighting system.

FIG. 9A depicts a top elevation view of a light module, according to certain embodiments.

FIG. 9B depicts a bottom elevation view of a light module, according to certain embodiments.

FIG. 10A through FIG. 10D depict elevation views of various light engines, according to certain embodiments.

FIG. 10E through FIG. 10H depict elevation views of various light modules, according to certain embodiments.

FIG. 10I presents an assembly view of a light module, according to certain embodiments.

FIG. 11 depicts a set of method steps for building a light emitting diode (LED) lighting system using light engines and/or light modules.

FIG. 12 depicts a block diagram of a system to perform certain method steps for building a light emitting diode (LED) lighting system using light engines and/or light modules.

### DETAILED DESCRIPTION

“Wireless connectivity” refers to other than wired connectivity, such as radio frequency or infrared, and includes connectivity at least in part over a wireless network including ZigBee, RFID, 6LoWPAN, DASH7, Ethernet, WiFi, etc. Wireless communications may use cordless phone radio frequency spectrum (or other spectrum ranges) and/or cordless phone modulation schemes and/or cordless phone protocols. Examples of cordless phone radio frequency spectrum ranges include: 1.7 MHz (1.64 MHz to 1.78 MHz and higher to 5 Channels, AM System), 43-50 MHz (cordless phone), 900 MHz (902-928 MHz) (e.g., cordless phone), 1.9 GHz (1880-1900 MHz) (used for DECT communications), 1.9 GHz (1920-1930 MHz) (used for DECT 6.0), 2.4 GHz (e.g., cordless phone), 5.8 GHz (e.g., cordless phone), or other ranges.

“Wired connectivity” refers to connectivity over wires and wired networks such as, for example, Ethernet and PLC.

The term “logic” means any combination of software or hardware that is used to implement all or part of the disclosure.

The term “non-transitory computer readable medium” refers to any medium that participates in providing instructions to a logic processor.

A “module” includes any mix of any portions of computer memory and any extent of circuitry including circuitry embodied as a processor.

The terms “controller” and “driver” are used interchangeably.

Reference is now made in detail to certain embodiments. The disclosed embodiments are not intended to be limiting of the claims.

Embodiments found in this disclosure circumvent the above problems by providing a solution wherein the fixture manufacturers can focus on what they are good at (design, secondary/tertiary optics, and controls). This is accomplished by providing lighting fixture manufacturers with an LED lamp that is separate from the driver (also referred to as a “deadhead” lamp) lighting product. For example, an MR16 deadhead product family can be provided within a standard ANSI form factor and standard stock keeping units (SKU) (e.g., spot, flood, narrow flood, etc.), but with the driver removed. This way, the deadhead lamp provides the complete LED, primary optics, and thermal solution (possibly including phosphors), and the fixture manufacturer can provide optimized driver electronics and controls (e.g., driver/controllers) for the LED lamp.

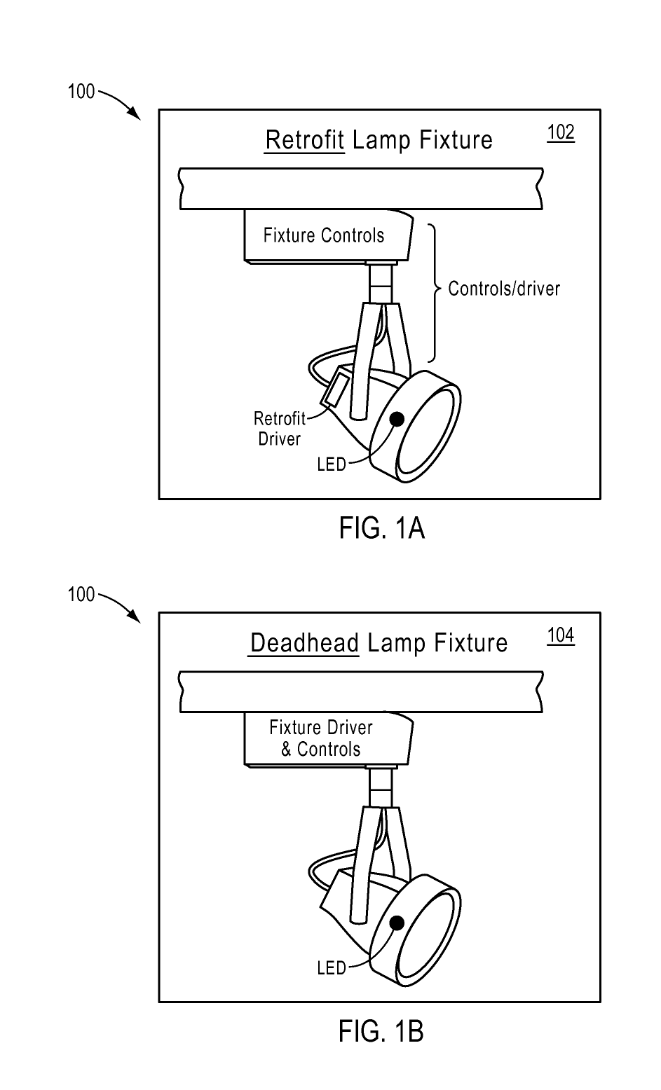

FIG. 1A and FIG. 1B present a comparison showing improvements in embodiments of LED lamps for lighting fixtures 100. More specifically, FIG. 1A shows a retrofit lamp fixture and FIG. 1B shows a deadhead lamp fixture. The retrofit lamp fixture 102 shown in FIG. 1A includes an LED lamp having an LED and a retrofit driver. The retrofit LED lamp is electrically coupled and physically mounted to a controller. The deadhead LED lamp 104 shown in FIG. 1B includes an LED lamp having an LED. The deadhead LED lamp is electrically connected and physically mounted to a controller that includes the driver and the controls for the LED lamp. As can be appreciated by comparing the two LED lamp fixtures, in the deadhead LED lamp fixture, the driver and the controller electronics are physically separated from the LED.

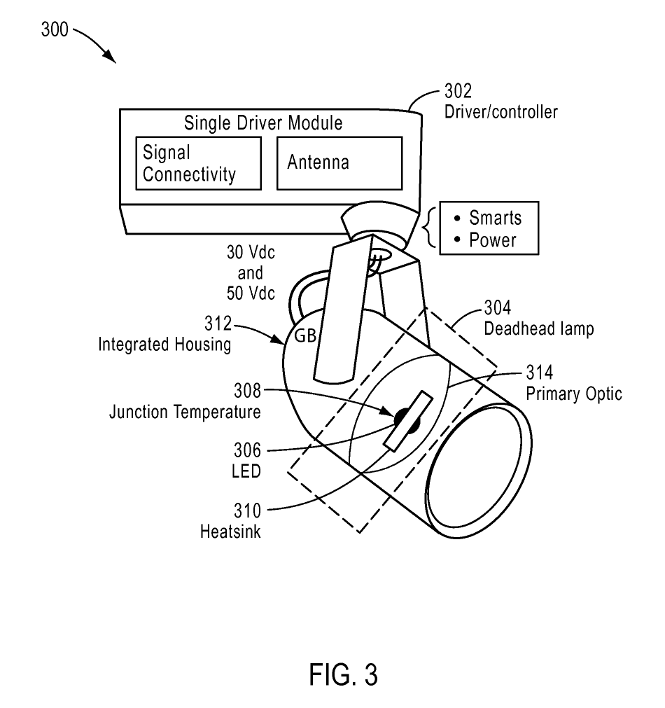

The benefits of the deadhead lamp fixture include, for example, (1) reduced total bill of materials (BOM) (one driver, vs. two); (2) reduced heat load for the LEDs (no driver heat in the lamp head); and (3) reduced BOM of the LED lamp (no driver). Furthermore, decoupling or separating the driver from the (hot) LED retrofit housing allows for simpler circuit design, use of lower cost components in the driver, and facilitates the incorporation of advanced control functions and connectivity (e.g., ZigBee). Separating the controller and associated connectivity from the constrained confines of the LED lamp enables the fixture manufacturer and its customers more flexibility in the choice of connectivity solutions—wired (e.g., Ethernet, PLC) or wireless (e.g., ZigBee, 6LoWPAN, DASH7, WiFi)—and standard temperature operation instead of high temperature, for the control of a single LED lamp, a plurality of LED lamps, and/or groups of LED lamps. The high-level concept is illustrated in FIG. 3 through FIG. 5.

Additional advantages are provided in Table 1.

TABLE 1
Comparisons

| Aspect | Retrofit Lamp | Remote Electronics Lamp |
|---|---|---|
| Driver | Integrated, | Remote (fixture) only |
| locations | Remote (fixture) | |
| Driver | ~80%-85% × | ~90% |
| efficiency | ~90% = ~72%-76% | |
| Lamp heat | LED + | LED heat only |
| | driver heat | (~15% reduction) |
| Control Features | Limited | Unlimited |
| Transformer and | Large | Small, because of low |
| driver size | | power requirement |
| Flicker | Limited options | Infinite options |
| Life Time | Limited | Longer, configurable |
| Driver | Integrated, | Remote |
| locations | Remote (fixture) | |
| Driver | Lower | Higher |
| efficiency | | |

In certain embodiments, communication between the deadhead lamp and the fixture must be specified. For example, the electrical interface (input voltage and current) for the lamp must be selected. In certain embodiments, the multi-die kitting platform developed by Soraa, Inc. (Fremont, Calif.) offers the flexibility to provide a well-controlled electrical interface with a variety of voltage/current options (e.g., 30V/350 mA DC). In certain embodiments, to avoid inserting a standard retrofit lamp into a fixture designed for a deadhead lamp provided by the present disclosure, a socket for the deadhead fixture can be configured to only accept deadhead lamps.

One advantage of LED lighting systems provided by the present disclosure is that the LED operating temperature is decoupled from the temperature generated by the driver electronics. With concerns about thermal management issued associated with the driver electronics no longer an issue, the output power of a deadhead lamp becomes only limited, at least in part, by the maximum operating temperature of the LED light source component. With GaN-on-GaN technology, this limit may be well beyond today's current operating temperatures. Indeed, manufacturers of silicones (often the “weakest link” in high temperature operation for LEDs) claim roadmaps of 175° C. to 200° C. operation, and certain phosphors are known to operate in similar regimes. With dedicated effort on GaN-on-GaN technology, operating temperatures for LEDs can exceed today's temperatures of 120° C. to 175° C. Using deadhead lamp fixtures, the additional power handling capability is delivered without adversely affecting the driver electronics. This can exploited in at least two ways: (1) reducing the area of LED wafer material for a lower cost light source component, and/or (2) by increasing light output for the fixture.

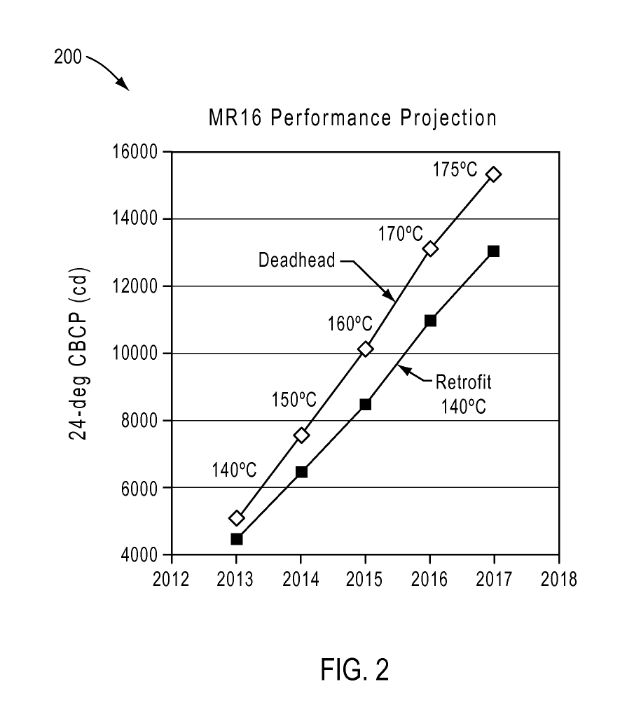

FIG. 2 shows a 24-degree MR16 center-beam candle-power (CBCP) for directional lighting fixtures, in the form of a roadmap showing both the standard retrofit lamp and the deadhead lamp configuration. The projected performance gains shown in FIG. 2 for the retrofit lamp configuration are estimated to be worst-case because they do not include improvements in efficiency for the LED at temperatures above 140° C. that can expected once the 140° C. limit is removed (the standard roadmap is locked to 140° C.).

Alternatively, the higher temperature operation may be leveraged to reduce cost. At a minimum, the LED BOM should reduce as much as the light output gains in the figure above. In reality, the gains will be higher because considerable reduction in semiconductor (epi) and package real estate can be leveraged, which could further lead to a smaller lamp form factor (e.g., MR11 vs. MR16). This approach is important once deadhead lamp performance reaches the “good enough” point and it is important to reduce end-to-end BOM cost of the luminaire.

The deadhead lamp fixture concept affords a strong value proposition and sensible business model to the fixture manufacturer while allowing the LED manufacturer to focus on its core competency of LED performance at high power densities and temperatures, and as determined by innovations in GaN-on-GaN and related solid-state lighting materials and device construction.

FIG. 3 is a diagram of a lighting fixture 300 showing improvements for LED lamps for lighting fixtures. As shown in FIG. 3, a single driver module (driver/controller 302) comprises a controller for signal connectivity and an antenna. The driver/controller 302 is electrically coupled to the deadhead lamp 304 and provides power to the LED at a voltage, for example, of 30 VDC, 50 VDC or other suitable voltage, though wires. The integrated housing 312, which contains the deadhead lamp 304 including LED 306, heatsink 310, and primary optic 314, is physically connected to the single driver module with a mount. The junction temperature may be measured at location 308.

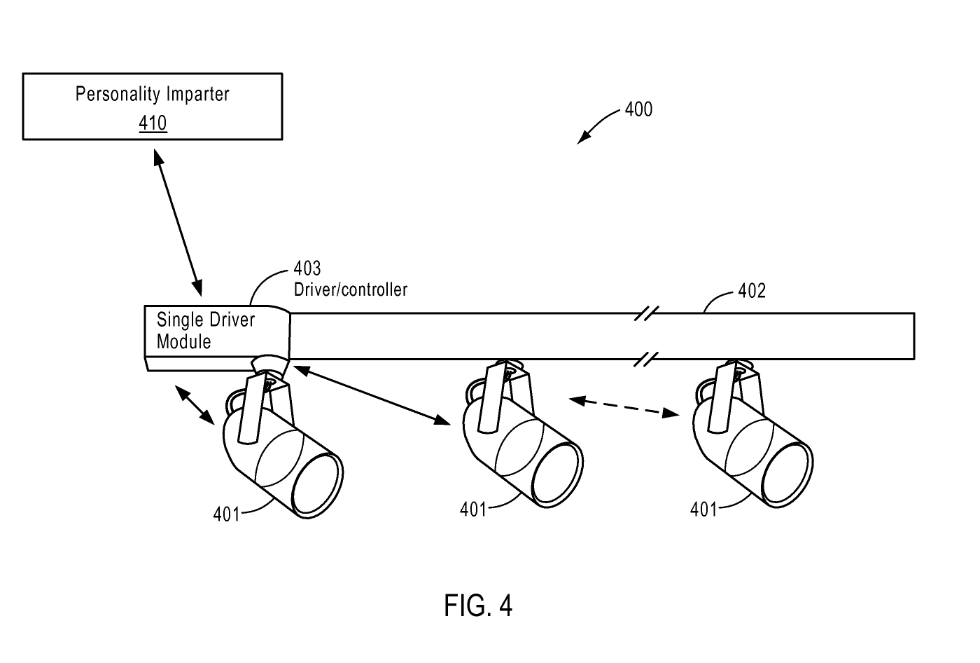

FIG. 4 shows an example of a lighting system 400 showing a multiple deadhead arrangement using a single driver module couple to multiple lighting fixtures according to certain embodiments. As shown in FIG. 4, three deadhead lamps 401 are mounted on a track lighting fixture 402 and electrically coupled to a single driver module, driver/controller 403. The single driver module 403 comprises a controller for signal connectivity and an antenna. In certain embodiments, driver/controller 403 may be configured for communication with a personality imparter 410 via a wireless or wired connection. Individual deadhead lamps 401 may be configured for communication with the driver/controller 403 and/or with each other via a wireless or wired connection.

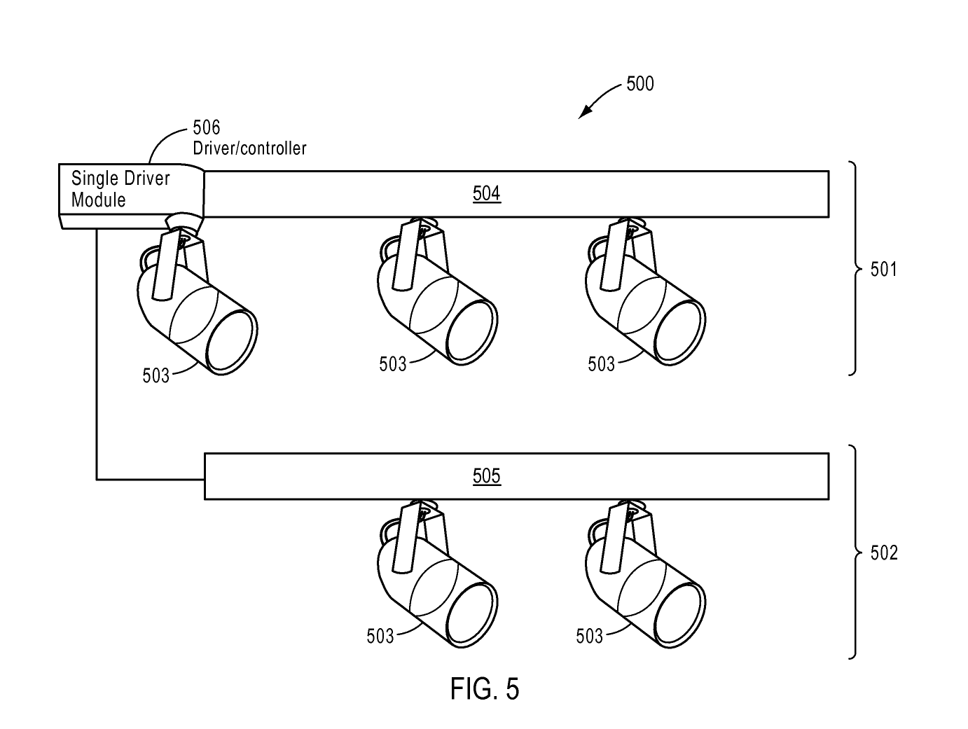

FIG. 5 shows an example of a lighting infrastructure 500 with multiple lighting systems having deadhead lamps and a single driver operating the multiple lighting systems according to certain embodiments. As shown in FIG. 5, lighting system 501 includes three deadhead lamps 503 mounted on a first track lighting fixture 504, and lighting system 502 includes two deadhead lamps 503 mounted on a second track lighting fixture 505. The single driver module 506 comprises a controller for signal connectivity and an antenna. The single driver module 506 is shown mounted to the first track lighting fixture 504. Driver/controller module 506 may be in communication with each of the deadhead lamps 503 independently, with lighting system 501 deadhead lamps separately, with lighting system 502 deadhead lamps separately, or with any combination of deadhead lamps 503 in lighting systems 501 and/or lighting system 502.

The embodiments depict but a few form factors. For example, some of the embodiments refer to a MR-16 form factor, however, the embodiments can be implanted with many form factors, standards, and configurations of LED lamps including pins for power connections, various types of bases, etc. For example, Table 2 gives standards (see “Designation”) and corresponding characteristics for several lighting form factors for use with the disclosed invention.

TABLE 2
Base standards

| | Base | | IEC |
|---|---|---|---|
| | Diameter | | 60061-1 |
| Desig- | (crest of | | Standard |
| nation | thread) | Name | Sheet |
| E05 | 05 mm | Lilliput Edison | 7004-25 |
| | | Screw (LES) | |
| E10 | 10 mm | Miniature Edison | 7004-22 |
| | | Screw (MES) | |
| E11 | 11 mm | Mini-Candelabra Edison | (7004-06-1) |
| | | Screw (mini-can) | |
| E12 | 12 mm | Candelabra Edison | 7004-28 |
| | | Screw (CES) | |
| E14 | 14 mm | Small Edison Screw (SES) | 7004-23 |
| E17 | 17 mm | Intermediate Edison | 7004-26 |
| | | Screw (IES) | |
| E26 | 26 mm | [Medium] (one-inch) | 7004-21A-2 |
| | | Edison Screw (ES or MES) | |
| E27 | 27 mm | [Medium] Edison | 7004-21 |
| | | Screw (ES) | |
| E29 | 29 mm | [Admedium] Edison | |
| | | Screw (ES) | |
| E39 | 39 mm | Single-contact (Mogul) | 7004-24-A1 |
| | | Giant Edison Screw (GES) | |
| E40 | 40 mm | (Mogul) Giant Edison Screw | 7004-24 |
| | | (GES) | |

Additionally, a base member (e.g., shell, casing, etc.) can be of any form factor configured to support electrical connections, which electrical connections can conform to any of a set of types or standards. For example, Table 3 gives standards (see “Type”) and corresponding characteristics, including mechanical spacing between a first pin (e.g., a power pin) and a second pin (e.g., a ground pin).

TABLE 3
Electrical Connection Standards

| | | Pin (center | Pin | |
|---|---|---|---|---|
| Type | Standard | to center) | Diameter | Usage |
| G4 | IEC 60061-1 | 4.0 mm | 0.65-0.75 mm | MR11 and other small halogens |
| | (7004-72) | | | of 5/10/20 watt and 6/12 volt |
| GU4 | IEC 60061-1 | 4.0 mm | 0.95-1.05 mm | |
| | (7004-108) | | | |
| GY4 | IEC 60061-1 | 4.0 mm | 0.65-0.75 mm | |
| | (7004-72A) | | | |
| GZ4 | IEC 60061-1 | 4.0 mm | 0.95-1.05 mm | |
| | (7004-64) | | | |
| G5 | IEC 60061-1 | 5 mm | | T4 and T5 fluorescent tubes |
| | (7004-52-5) | | | |
| G5.3 | IEC 60061-1 | 5.33 mm | 1.47-1.65 mm | |
| | (7004-73) | | | |
| G5.3-4.8 | IEC 60061-1 | | | |
| | (7004-126-1) | | | |
| GU5.3 | IEC 60061-1 | 5.33 mm | 1.45-1.6 mm | |
| | (7004-109) | | | |
| GX5.3 | IEC 60061-1 | 5.33 mm | 1.45-1.6 mm | MR16 and other small halogens |
| | (7004-73A) | | | of 20/35/50 watt and 12/24 volt |
| GY5.3 | IEC 60061-1 | 5.33 mm | | |
| | (7004-73B) | | | |
| G6.35 | IEC 60061-1 | 6.35 mm | 0.95-1.05 mm | |
| | (7004-59) | | | |
| GX6.35 | IEC 60061-1 | 6.35 mm | 0.95-1.05 mm | |
| | (7004-59) | | | |
| GY6.35 | IEC 60061-1 | 6.35 mm | 1.2-1.3 mm | Halogen 100 W 120 V |
| | (7004-59) | | | |
| GZ6.35 | IEC 60061-1 | 6.35 mm | 0.95-1.05 mm | |
| | (7004-59A) | | | |
| G8 | | 8.0 mm | | Halogen 100 W 120 V |
| GY8.6 | | 8.6 mm | | Halogen 100 W 120 V |
| G9 | IEC 60061-1 | 9.0 mm | | Halogen 120 V (US)/230 V (EU) |
| | (7004-129) | | | |
| G9.5 | | 9.5 mm | 3.10-3.25 mm | Common for theatre use, several |
| | | | | variants |
| GU10 | | 10 mm | | Twist-lock 120/230-volt MR16 |
| | | | | halogen lighting of 35/50 watt, |
| | | | | since mid-2000s |
| G12 | | 12.0 mm | 2.35 mm | Used in theatre and single-end |
| | | | | metal halide lamps |
| G13 | | 12.7 mm | | T8 and T12 fluorescent tubes |
| G23 | | 23 mm | 2 mm | |
| GU24 | | 24 mm | | Twist-lock for self-ballasted |
| | | | | compact fluorescents, since 2000s |
| G38 | | 38 mm | | Mostly used for high-wattage theatre |
| | | | | lamps |
| GX53 | | 53 mm | | Twist-lock for puck-shaped under- |
| | | | | cabinet compact fluorescents, since 2000s |

In certain embodiments of an LED lighting system, an LED is operated at a junction temperature 15° C. or higher than that of electrical components in a driver/controller.

In certain embodiments, an LED lighting system comprises an LED, a primary optic, and a heatsink in an integrated housing, and a driver/controller system electrically connected to the LED and positioned outside the integrated housing.

In certain embodiments, a driver/controller system has connectivity functionality to enable electronic communication to and/or from a LED lighting system.

In certain embodiments, an LED lighting system comprises a single driver module for each deadhead lamp.

In certain embodiments, an LED lighting system comprises a single driver module for multiple deadhead lamps (this requires voltage drive of the dead head lamp).

In certain embodiments, an LED lighting infrastructure comprises multiple LED lighting systems, each LED lighting system comprising multiple deadhead lamps and a single driver for each system.

In certain embodiments, an LED lighting system comprises an LED, a primary optic, and a heatsink in an integrated housing, and a driver/controller system that is logically connected to the LED and positioned outside the integrated housing.

In certain embodiments, an LED lighting system the logical connection comprises a wireless logical coupling such as Dash7 or others.

In certain embodiments, an LED lighting system comprises at least one LED and at least one controller, wherein the LED is operated at a junction temperature that is at least 15° C. higher than a temperature of the controller. In certain embodiments, the at least one controller comprises a housing and at least one electronic component; and the temperature of the controller is measured within the housing. In certain embodiments, the temperature is measured at the surface of the at least one electronic component.

In certain embodiments provided by the present disclosure, an LED lighting system comprises an integrated LED lamp comprising a housing, an LED, a primary optic, and a heatsink; and a controller electrically coupled to the LED and separate from the integrated LED lamp. In certain embodiments, the controller comprises circuitry configured to send communications to the LED and to receive communications from the LED. In certain embodiments, the controller is logically coupled to the LED by a providing wireless communication. In certain embodiments, the controller provides electrical power to the LED. In certain embodiments, the integrated lamp is physically mounted on the controller. In certain embodiments, the controller is configured to control illumination characteristics selected from intensity, direction, color, duration, rate of change, and a combination of any of the foregoing. In certain embodiments of an LED lighting system provided by the present disclosure, the system comprises a plurality of LEDs wherein each of the plurality of LEDs is electrically coupled to a separate controller. In certain embodiments, a controller electrically coupled to a plurality of LEDs.

In certain embodiments, an LED lighting infrastructure comprises a plurality of controllers, wherein each of the plurality of controllers is electrically coupled to a plurality of LEDs. The controller may be electrically coupled to one or more LED lighting systems, wherein each of the one or more LED lighting systems comprises a plurality of LEDs, and in certain embodiments, the controller is configured to independently control each of the one or more LED lighting systems.

In certain embodiments, an LED lighting system comprises an integrated LED lamp comprising an LED, a primary optic, and a heatsink; and a controller module logically coupled to the LED; the controller module being separated by a distance of at least 3 inches from the integrated housing. In certain embodiments, a controller module comprises circuitry configured to send communications to the LED and to receive communications from the LED. Communications may be by wireless communication or wired communication. In certain embodiments, the infrastructure comprises at least one lighting fixture. In certain embodiments, the plurality of LEDs of at least one of the LED lighting systems is physically attached to a lighting fixture. In certain embodiments, the controller is physically attached to a fixture. A controller may be configured to control illumination characteristics of the one or more LED lighting systems based on communication with one or more sensors. In certain embodiments, a controller may be configured to control illumination characteristics of the one or more LED lighting systems based on communication with one or more remote wireless networks. In certain embodiments in which the controller is configured to control illumination characteristics of the one or more LED lighting systems based on communication with one or more remote wireless devices.

Other functionality may be incorporated into a system or infrastructure disclosed herein. For example, each of the plurality of LEDs is configured to be recognized by an identification, and in certain embodiments, the identification is unique for each of the plurality of LEDs.

In certain embodiments, the plurality or one or more of the LEDs is operatively coupled to a directional orientation device. As such, certain lighting systems disclosed herein may be considered directional lighting systems. In certain embodiments, a directional orientation device is contained within the integrated lamp housing, and in certain embodiments, a directional orientation device is external to the integrated lamp housing. In certain embodiments, a directional orientation device is mounted on the fixture.

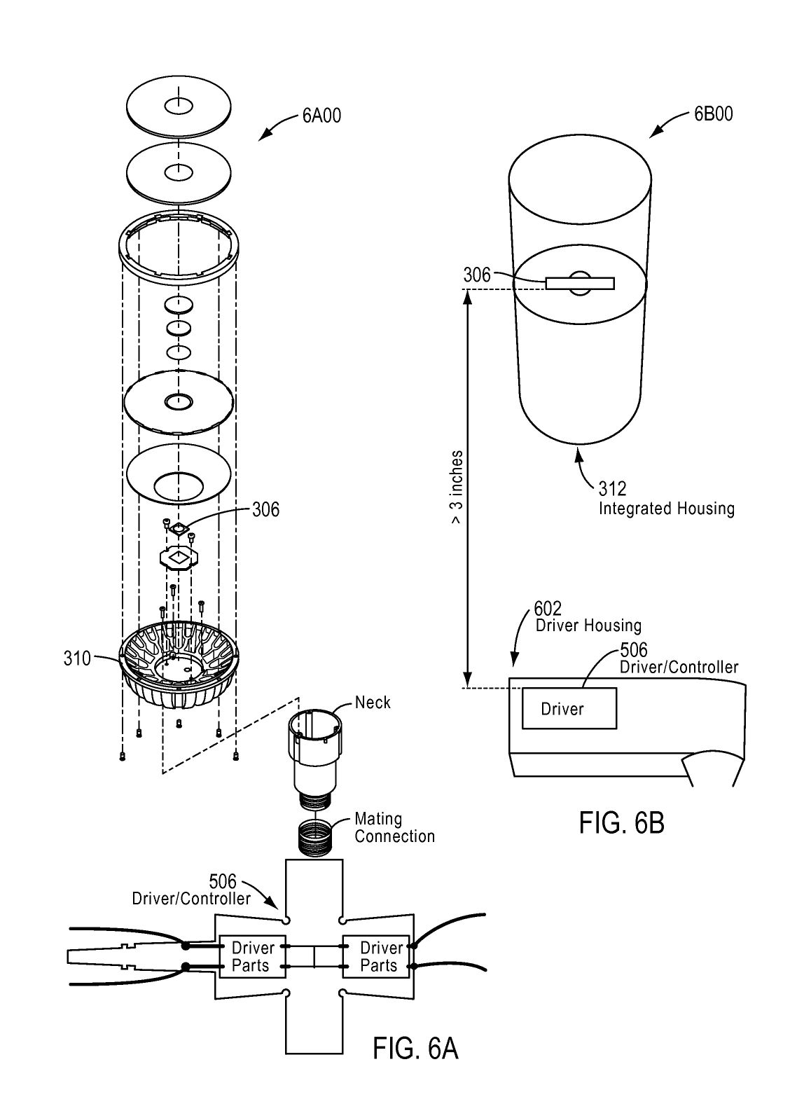

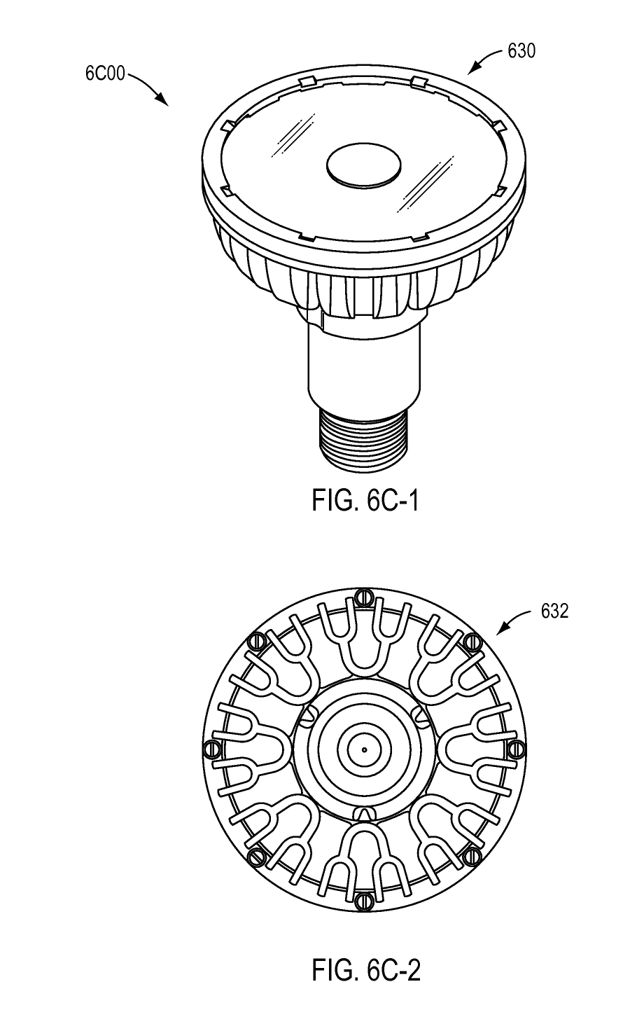

FIG. 6A and FIG. 6B show diagram 6A00 and diagram 6B00 for comparison. FIG. 6A depicts a selection of LED light source components (e.g., LED 306, light chip, etc.), a heatsink 310, a driver/controller 506, and other lamp components (e.g., a neck and a mating connector). As shown by comparing diagram 6A00 with diagram 6B00, the LED 306 is disposed within the integrated housing of FIG. 6B, and the driver/controller 506 is disposed within the driver housing 602. Further, FIG. 6B shows an integrated housing in juxtaposition with a distally-located driver module. The selection of LED light source components of FIG. 6A and selected lighting infrastructure components (e.g., integrated housing, driver/controller housing) are arranged in two separate groups.

FIG. 6C-1 and FIG. 6C-2 are diagrams 6C00 showing a perspective view 630 and a top view 632 for an LED lamp in a retrofit form factor (e.g., PAR30L) suited for use in the integrated housing and distally-located driver module of FIG. 6B. As shown, the LED lamp comports with an ANSI lamp form factor, namely PAR30L.

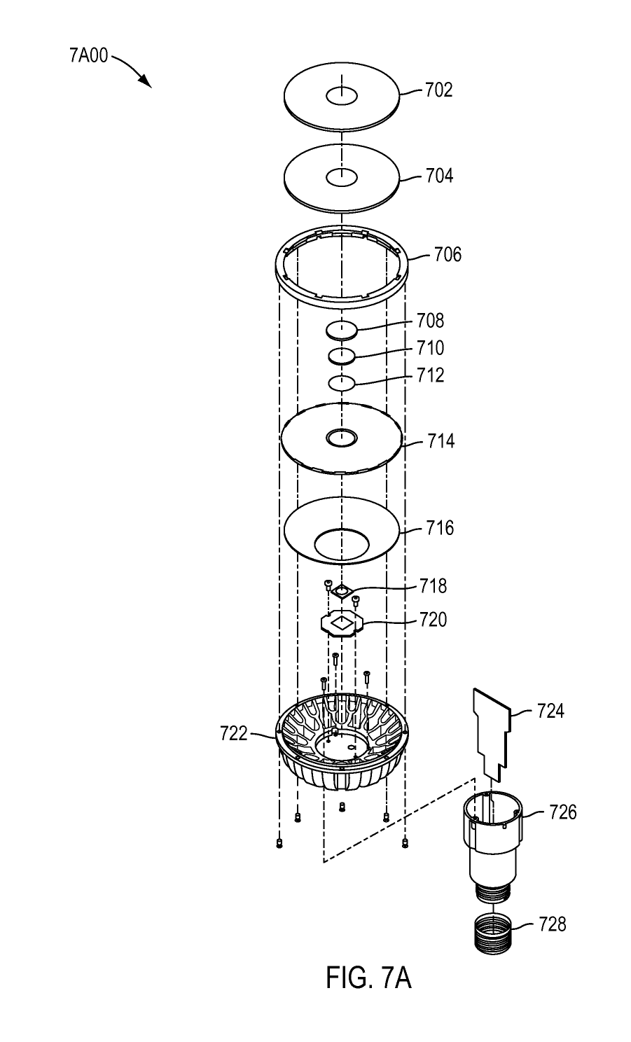

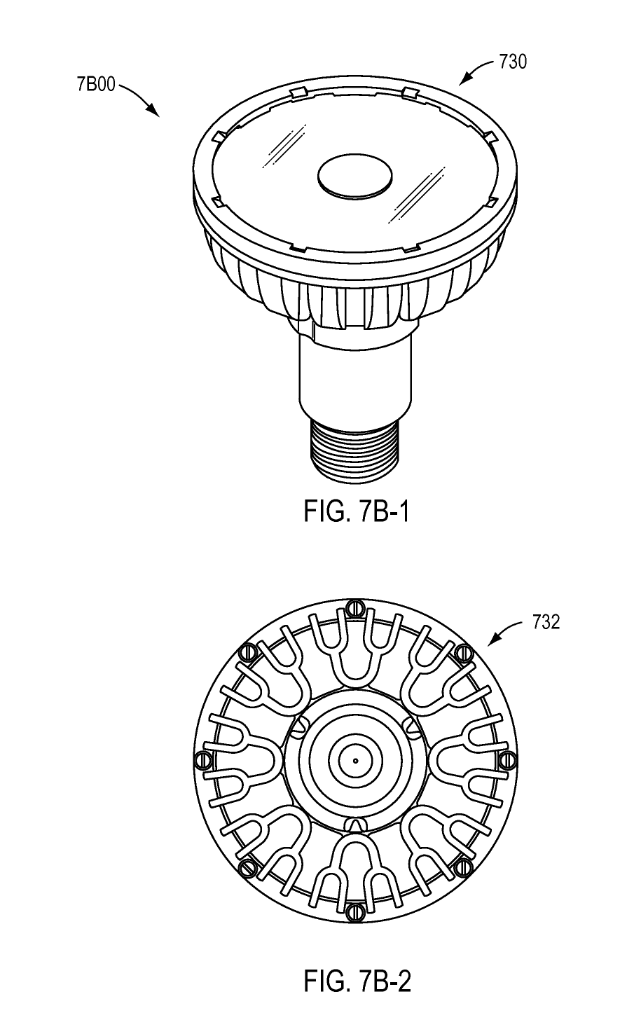

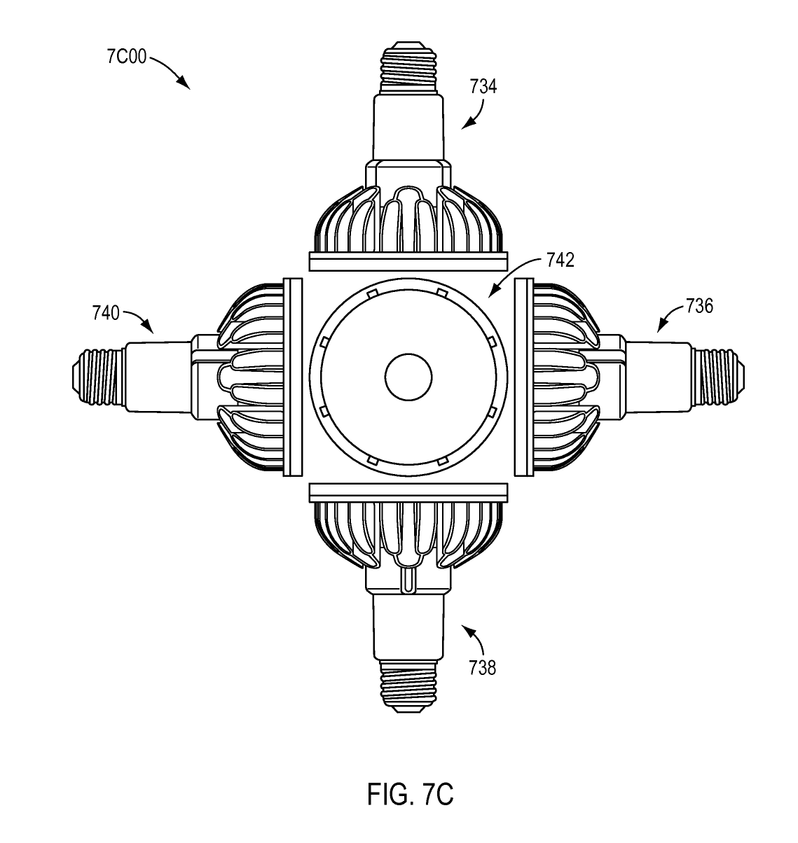

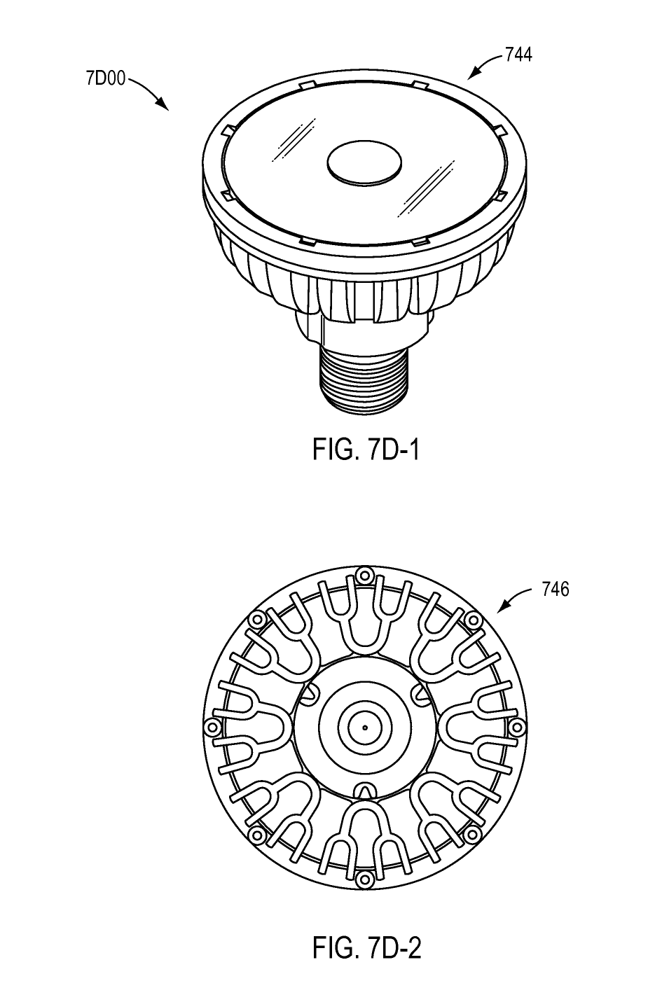

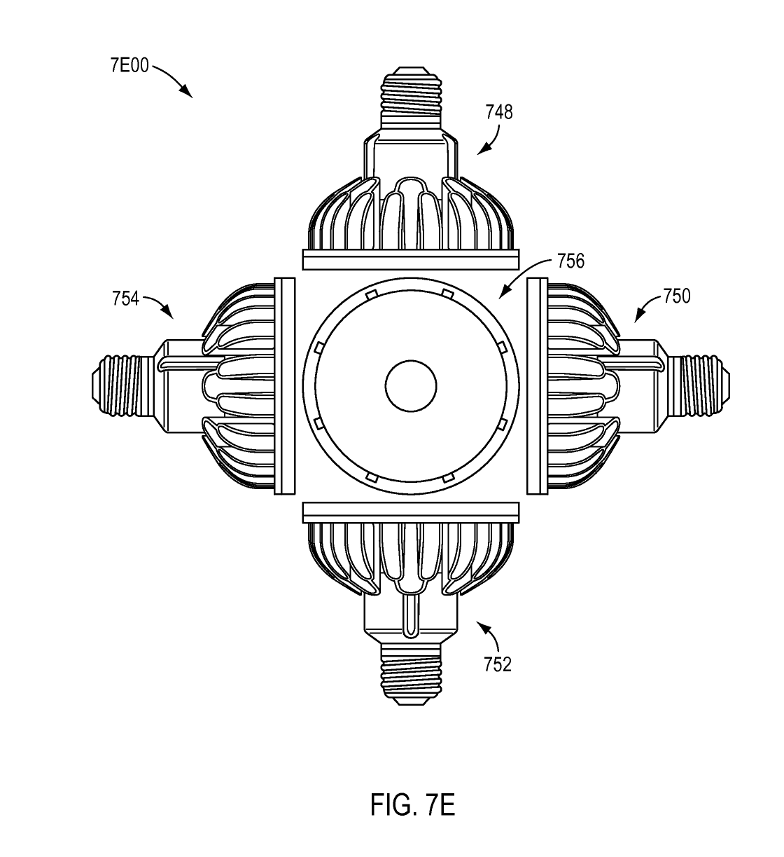

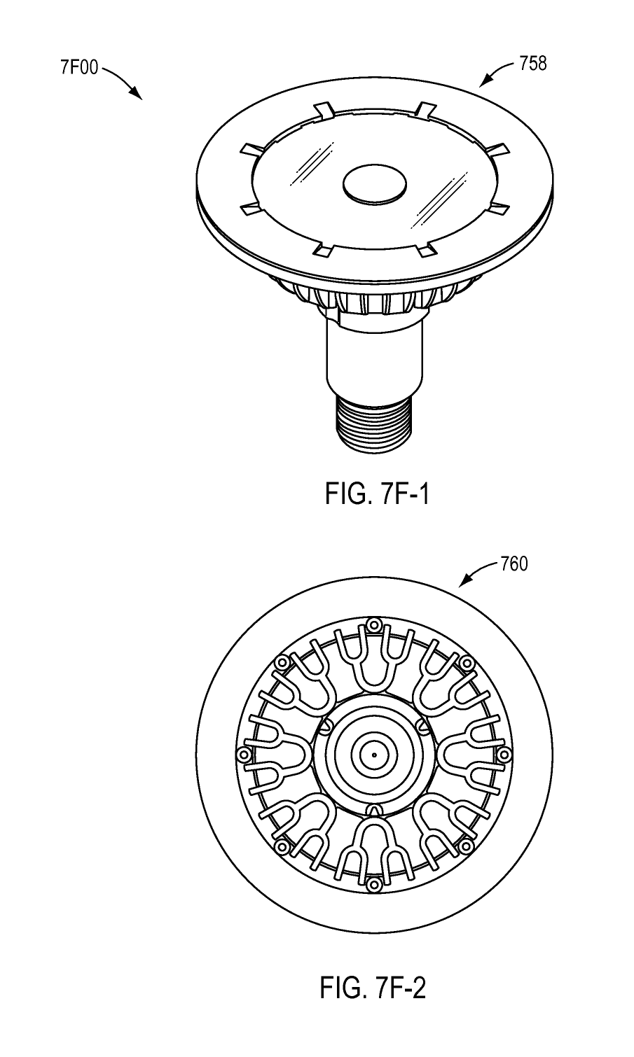

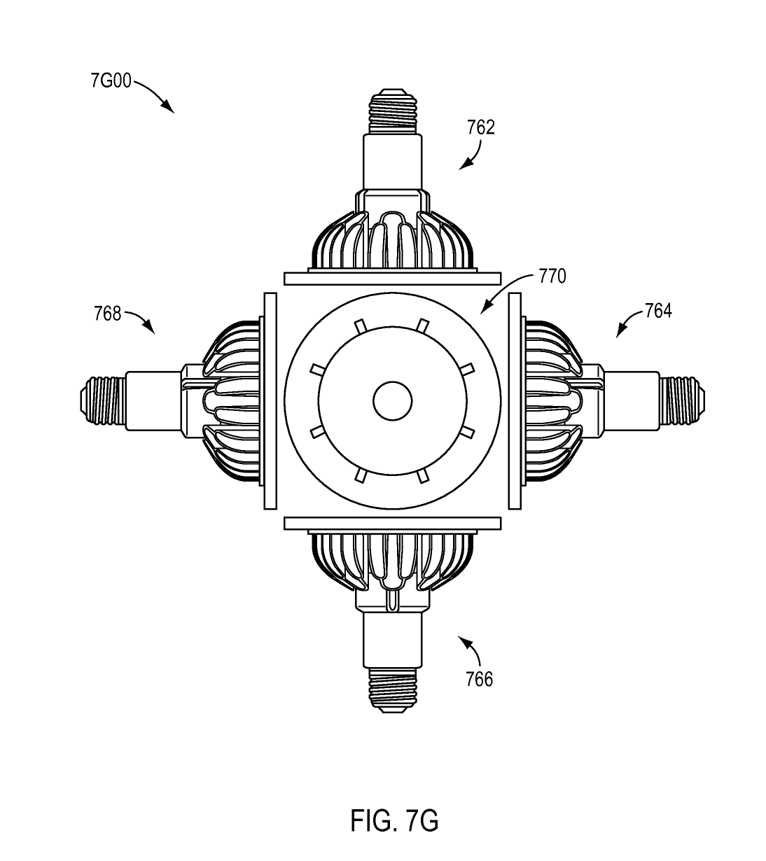

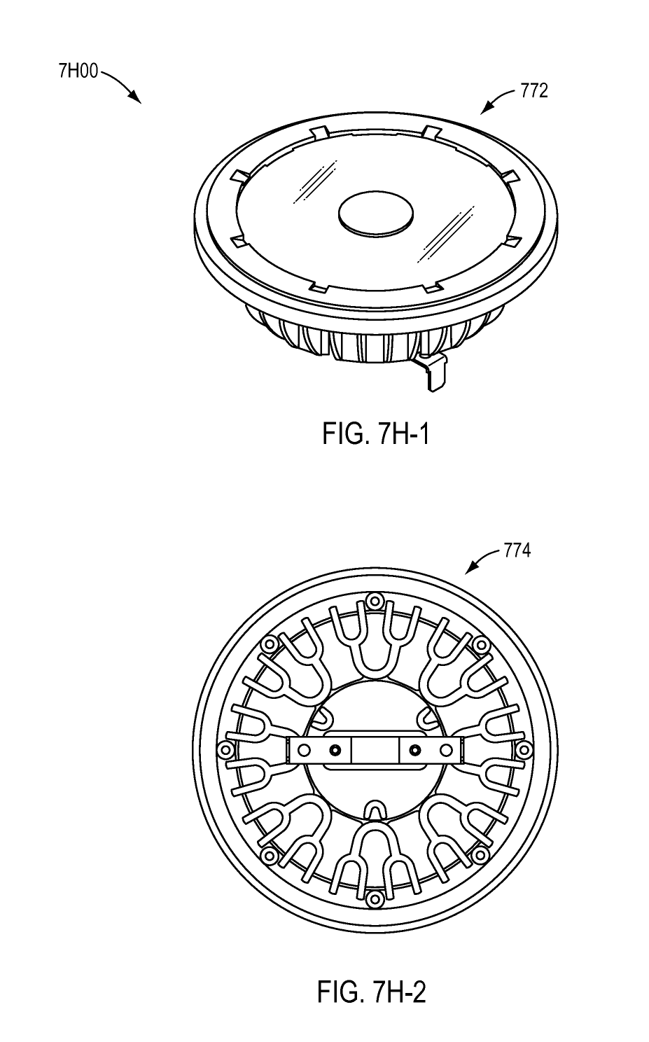

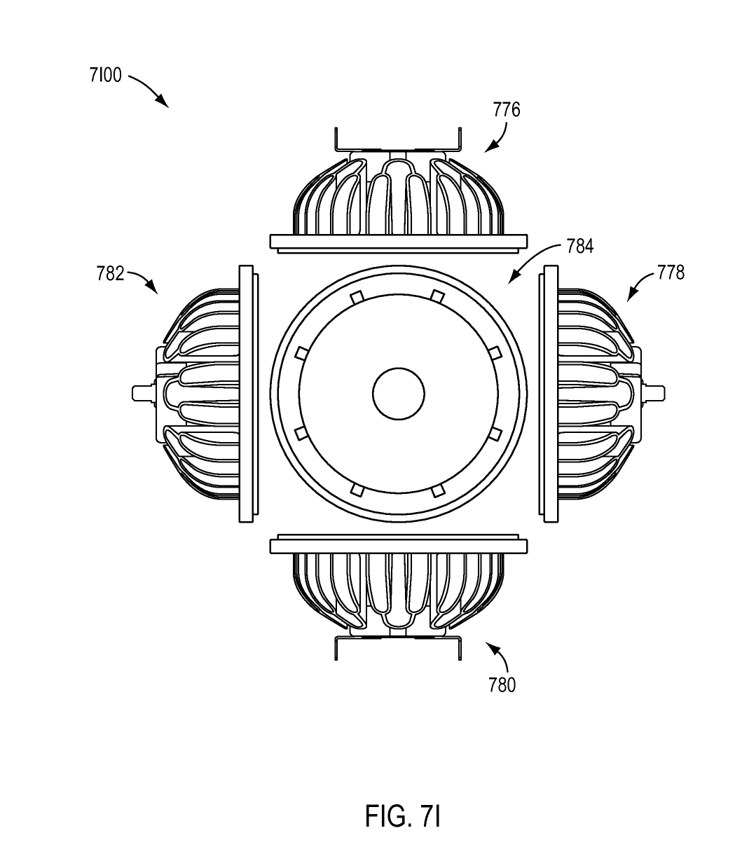

FIG. 7A through FIG. 7I depict embodiments of the present disclosure in the form of lamp applications. In these lamp applications, one or more light emitting diodes are used in lamps and fixtures. Such lamps and fixtures include replacement and/or retrofit directional lighting fixtures.

In some embodiments, aspects of the present disclosure can be used in an assembly. As shown in FIG. 7A, the assembly comprises:
a screw cap 728
a driver housing 726
a driver board 724
a heatsink 722
a metal-core printed circuit board 720
an LED light source 718
a dust shield 716
a lens 714
a reflector disc 712
a magnet 710
a magnet cap 708
a trim ring 706
a first accessory 704
a second accessory 702

The components of the assembly 7A00 can be fitted together to form a lamp. FIG. 7B-1 and FIG. 7B-2 depict a perspective view 730 and top view 732 of such a lamp. As shown in FIG. 7B, the lamp 7B00 comports to a form factor known as PAR30L. The PAR30L form factor is further depicted by the principal views (e.g., left 740, right 736, back 734, front 738 and top 742) given in array 7C00 of FIG. 7C.

The components of the assembly 7A00 can be fitted together to form a lamp. FIG. 7D-1 and FIG. 7D-2 depict a perspective view 744 and top view 746 of such a lamp. As shown in FIG. 7D-1 and FIG. 7D-2, the lamp 7D00 comports to a form factor known as PAR30S. The PAR30S form factor is further depicted by the principal views (e.g., left 754, right 750, back 748, front 752 and top 756) given in array 7E00 of FIG. 7E.

The components of the assembly 7A00 can be fitted together to form a lamp. FIG. 7F-1 and FIG. 7F-2 depict a perspective view 758 and top view 760 of such a lamp. As shown in FIG. 7F, the lamp 7F00 comports to a form factor known as PAR38. The PAR38 form factor is further depicted by the principal views (e.g., left 768, right 764, back 762, front 766 and top 770) given in array 7G00 of FIG. 7G.

The components of the assembly 7A00 can be fitted together to form a lamp. FIG. 7H-1 and FIG. 7H-2 depicts a perspective view 772 and top view 774 of such a lamp. As shown in FIG. 7H, the lamp 7H00 comports to a form factor known as PAR111. The PAR111 form factor is further depicted by the principal views (e.g., left 782, right 778, back 776, front 780 and top 784) given in array 7I00 of FIG. 7I.

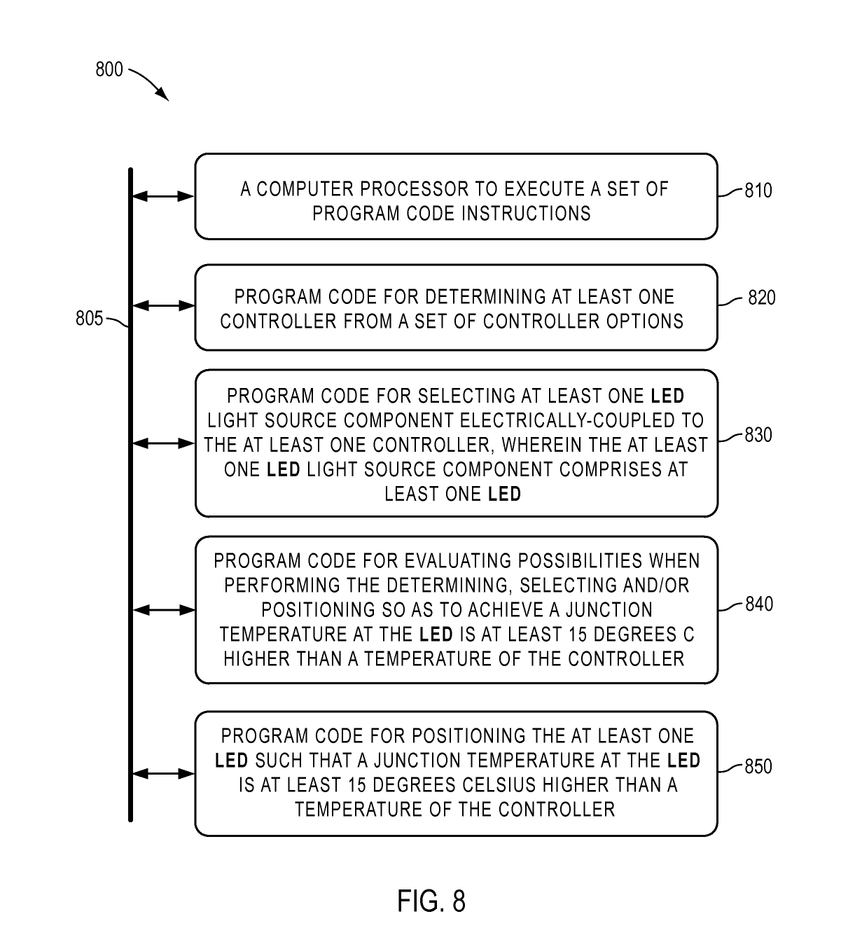

FIG. 8 depicts a block diagram of a system to perform certain method steps for building a light emitting diode (LED) lighting system. As shown, system 800 comprises at least one processor (see module 810) and at least one memory (not shown), the memory serving to store program instructions corresponding to the operations of the system. An operation (e.g. implemented in whole or in part using program instructions) is connected to a communication link 805, and any module can communicate with other modules over communication link 805. The modules of the system can individually or in combination, perform method steps within system 800. Any method steps performed within system 800 may be performed in any order unless as may be specified in the claims. As shown, FIG. 8 implements a light emitting diode (LED) lighting design system as system 800, comprising one or more program instructions for: determining at least one controller from a set of controller options (see module 820); selecting at least one LED light source component electrically-coupled to the at least one controller, wherein the at least one LED light source component comprises at least one LED (see module 830); and positioning the at least one LED such that a junction temperature at the LED is at least 15 degrees C. higher than a temperature of the controller (see module 850). Many possibilities may be evaluated when performing the steps of determining, selecting and/or positioning so as to achieve a junction temperature at the LED is at least 15 degrees Celsius higher than a temperature of the controller (see module 840). Also, many possibilities may be evaluated when performing the steps of determining, selecting and/or positioning so as to achieve temperature of the controller that is at least 15 degrees Celsius lower than a junction temperature at the LED (see module 840).

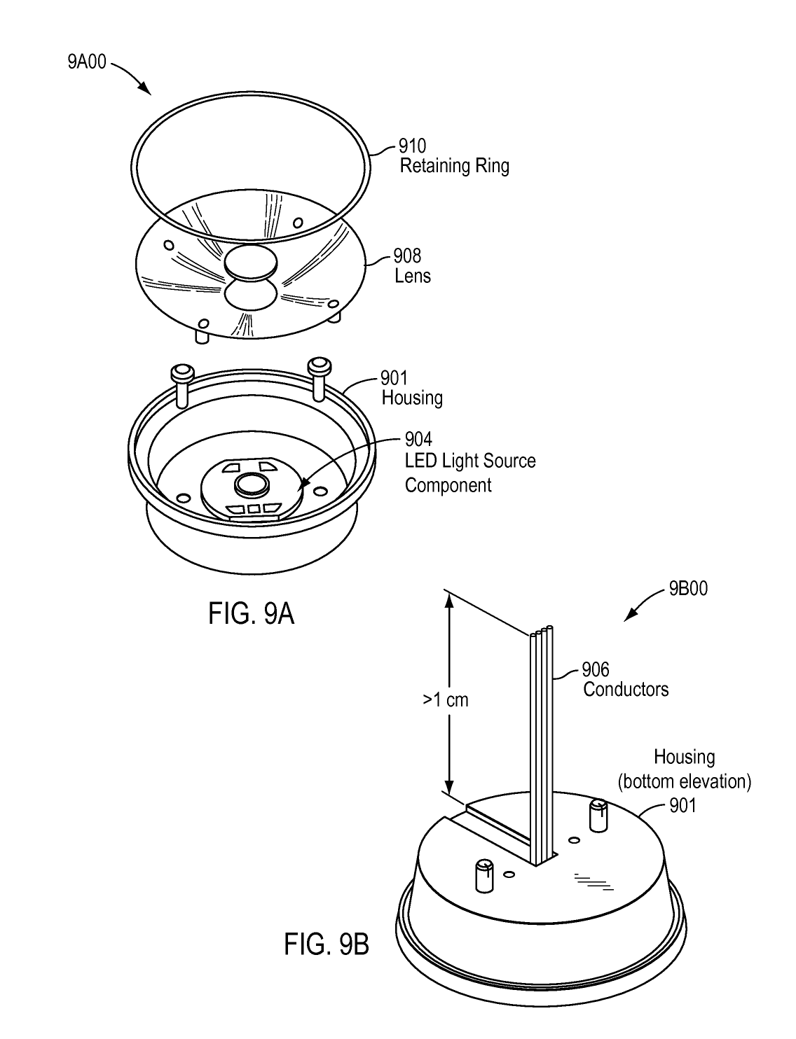

FIG. 9A depicts a top elevation view of a light module 9A00. As shown, the light module comprises a housing 901, a lens 908, and a retaining ring 910. Mounted within a cavity of the housing 901 is an LED light source component 904. The LED light source component 904 is powered via conductors (see 906 in FIG. 9B) that are electrically-connected to a driver module distally disposed from LED light source component 904.

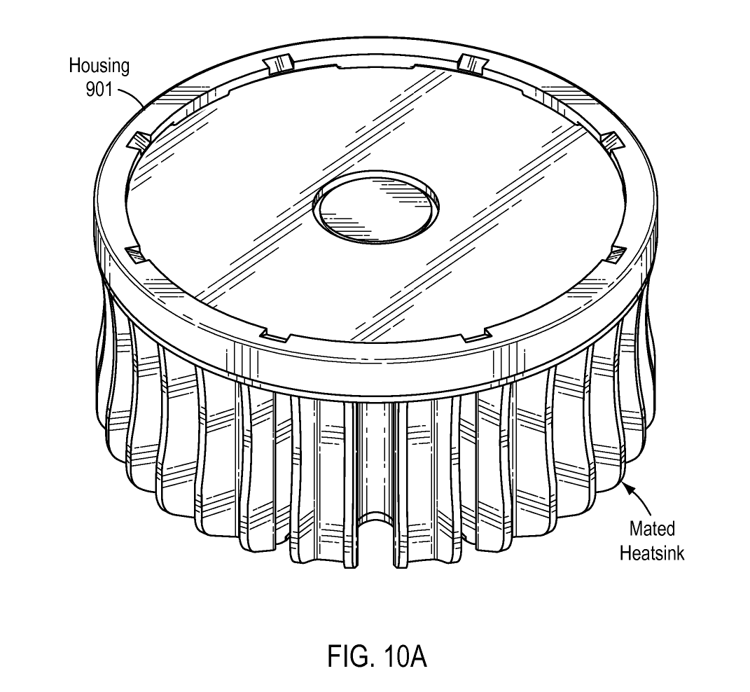

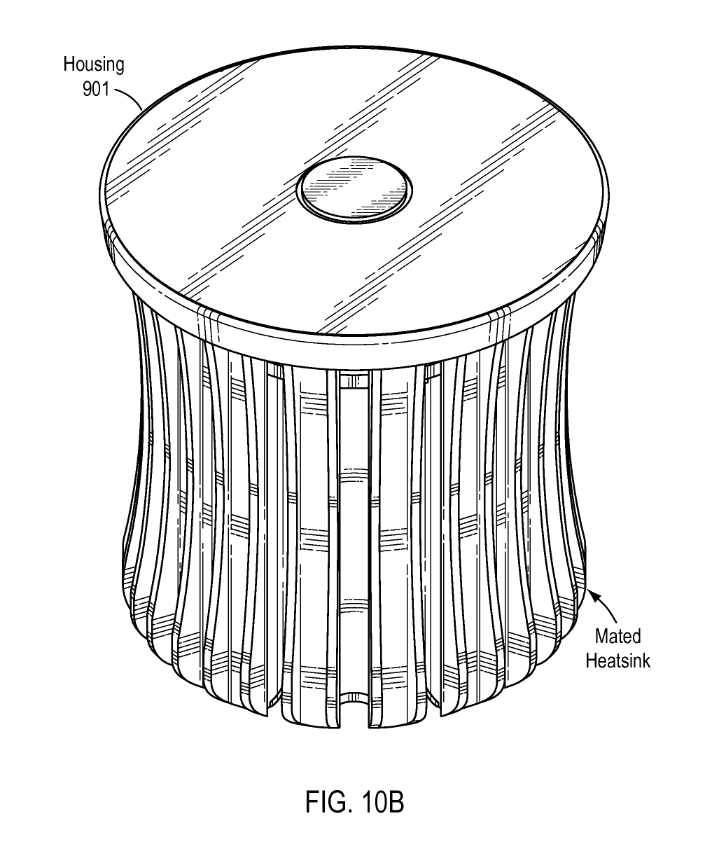

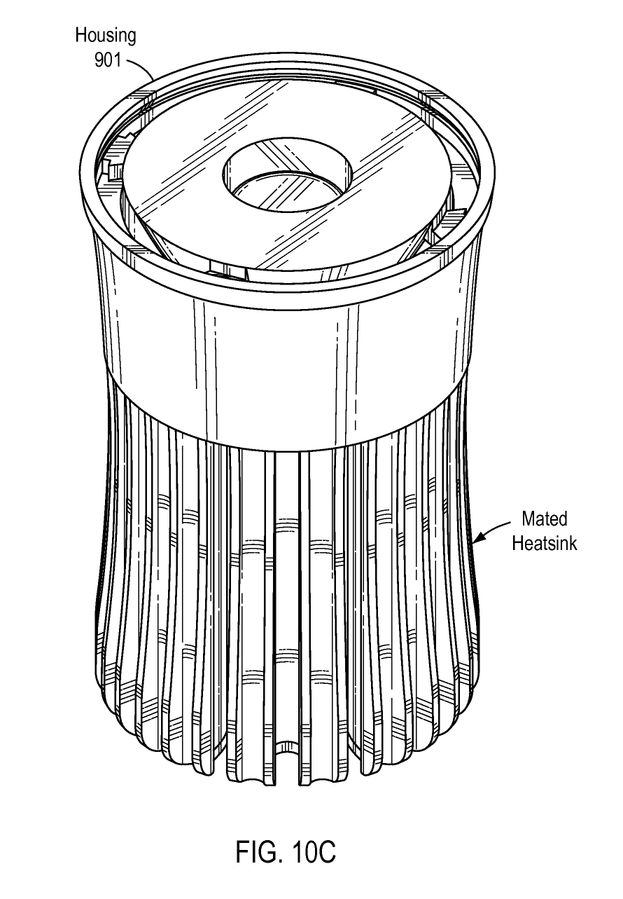

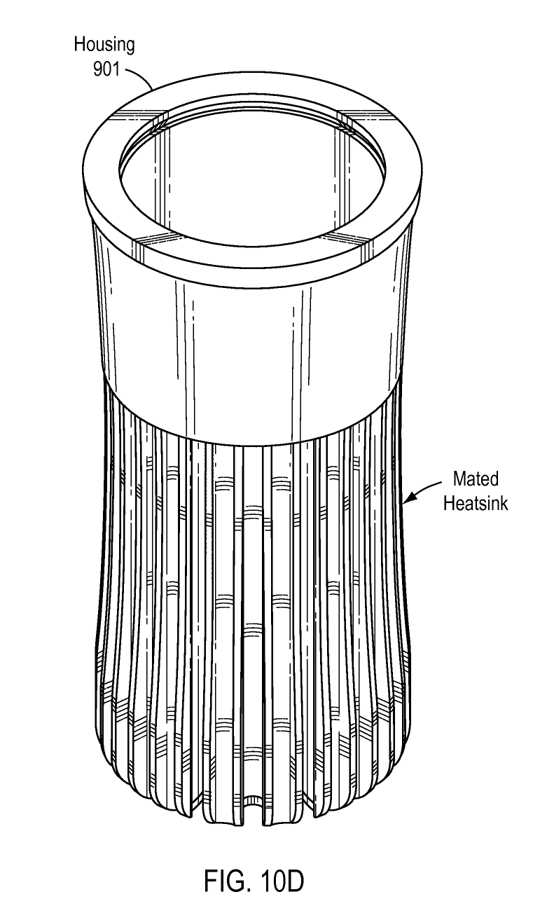

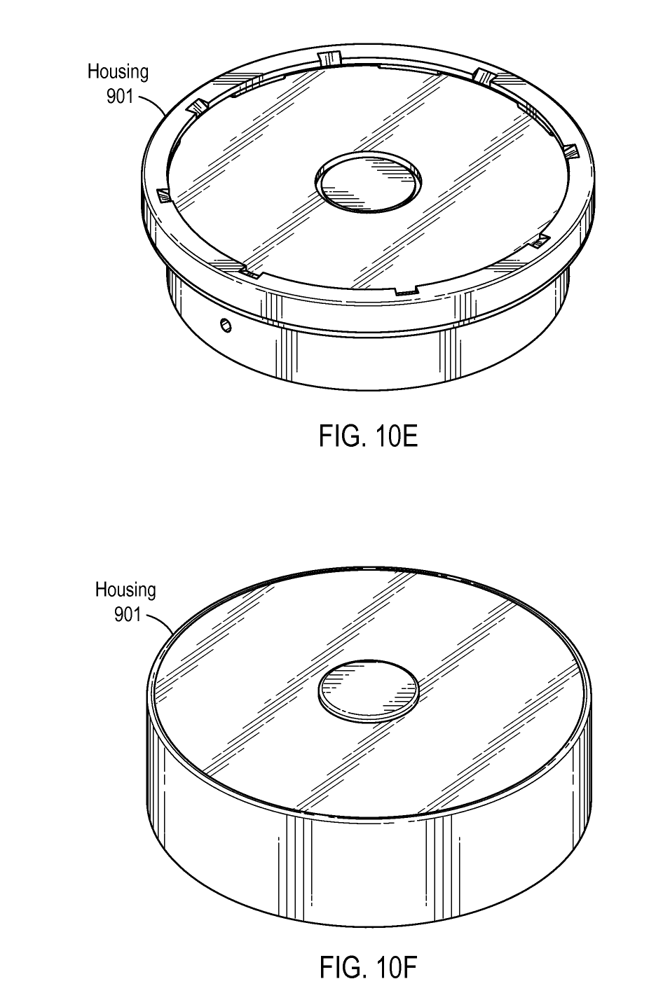

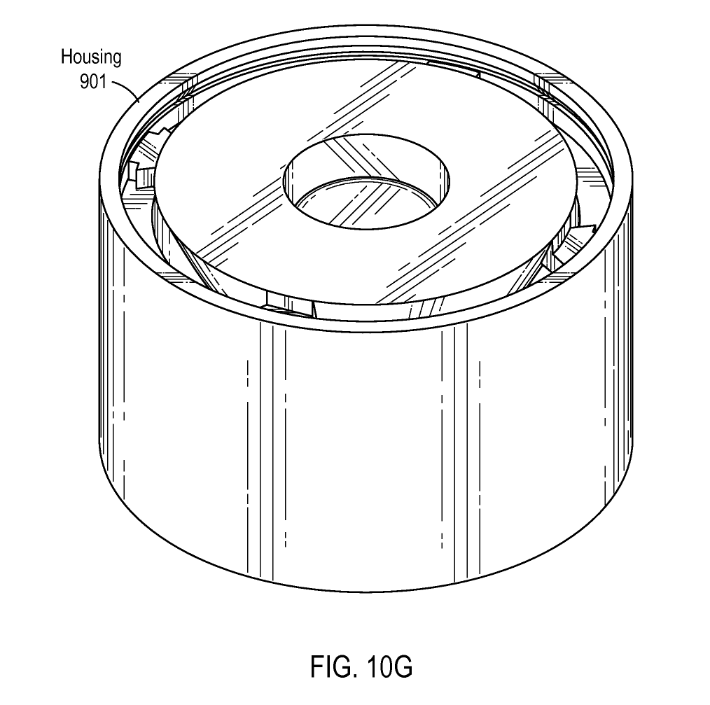

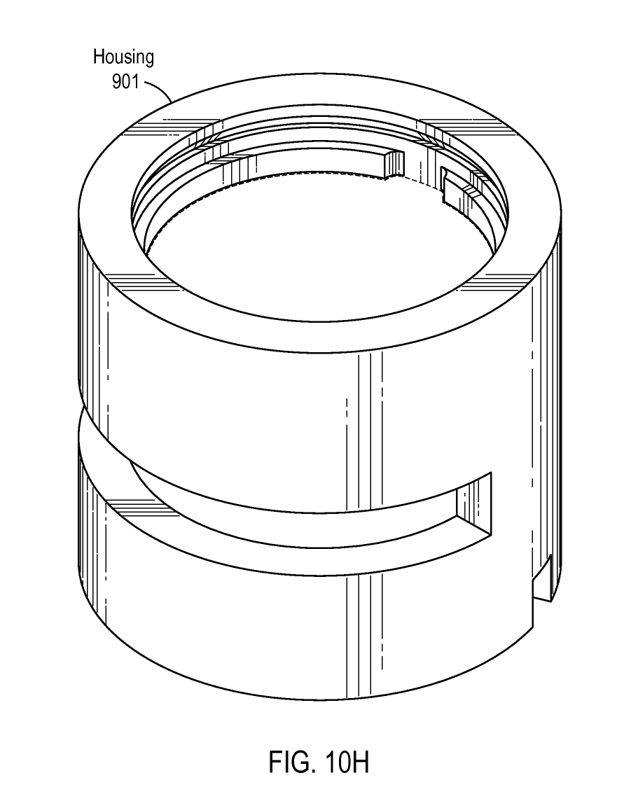

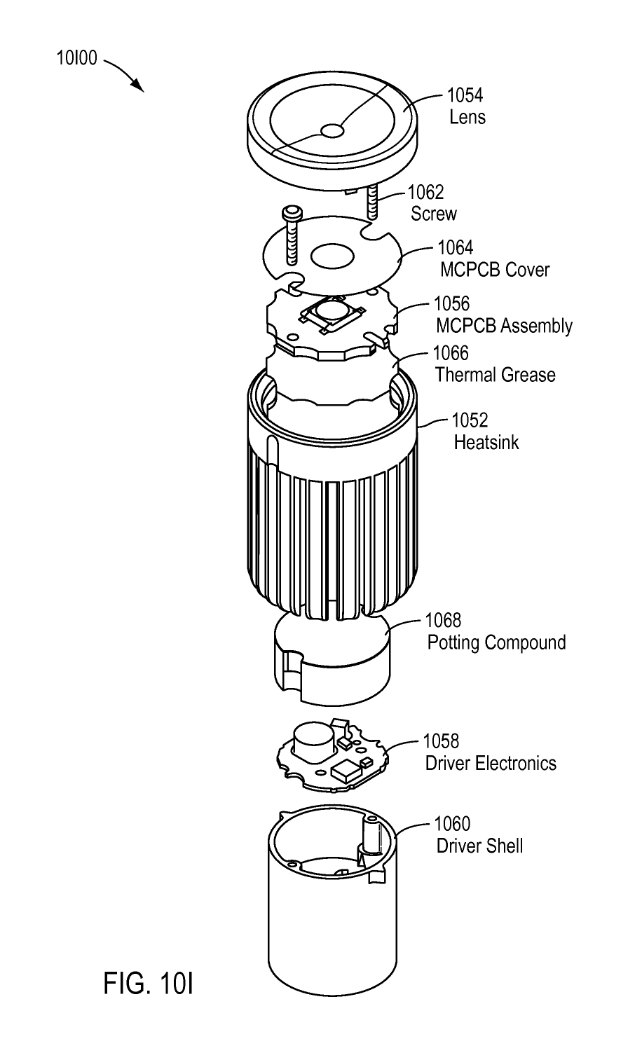

FIG. 9B depicts a bottom elevation view 9B00 of a light module. The LED light source component within the housing is powered via conductors 906 that are electrically-connected to a driver module distally disposed from the LED light source component. Such a light module can be combined with a heat sink to form a light engine. A selection of light engines is depicted in the following FIG. 10A through FIG. 10D.

FIG. 10A through FIG. 10D depict elevation views of various light engines in differing shapes and aspect ratios. The light engine concepts as shown and described in the foregoing FIG. 9A and FIG. 9B can be implemented in differing shapes and aspect ratios as is shown in FIG. 10A through FIG. 10D. In some situations, the mated heatsink as shown in FIG. 10A through FIG. 10D can be eliminated from a particular fixture design, and can be replaced by alternative thermal management structures. In such cases, the fixture can include a light module, some example of which are depicted in the following FIG. 10E through 10H.

FIG. 10E through FIG. 10H depict elevation views of various light modules.

FIG. 10I presents an assembly view 10100 of a light module. This assembly presented is merely one embodiment, many variations are possible. As shown, the assembly comprises a lens 1054, a metal core printed circuit board (MCPCB) such as the shown MCPCB assembly 1056, and a heatsink 1052. The MCPCB assembly is fastened to the heatsink using a layer of thermal grease 1066, one or more screws (see screw 1062) and an MCPCB cover 1064.

Another printed circuit board hosts driver electronics 1058, comprising at least one electronic component. The driver electronics 1058 are encased with a potting compound 1068, and then the driver electronics, together with a shaped portion of potting compound 1068, is disposed within a driver shell 1060.

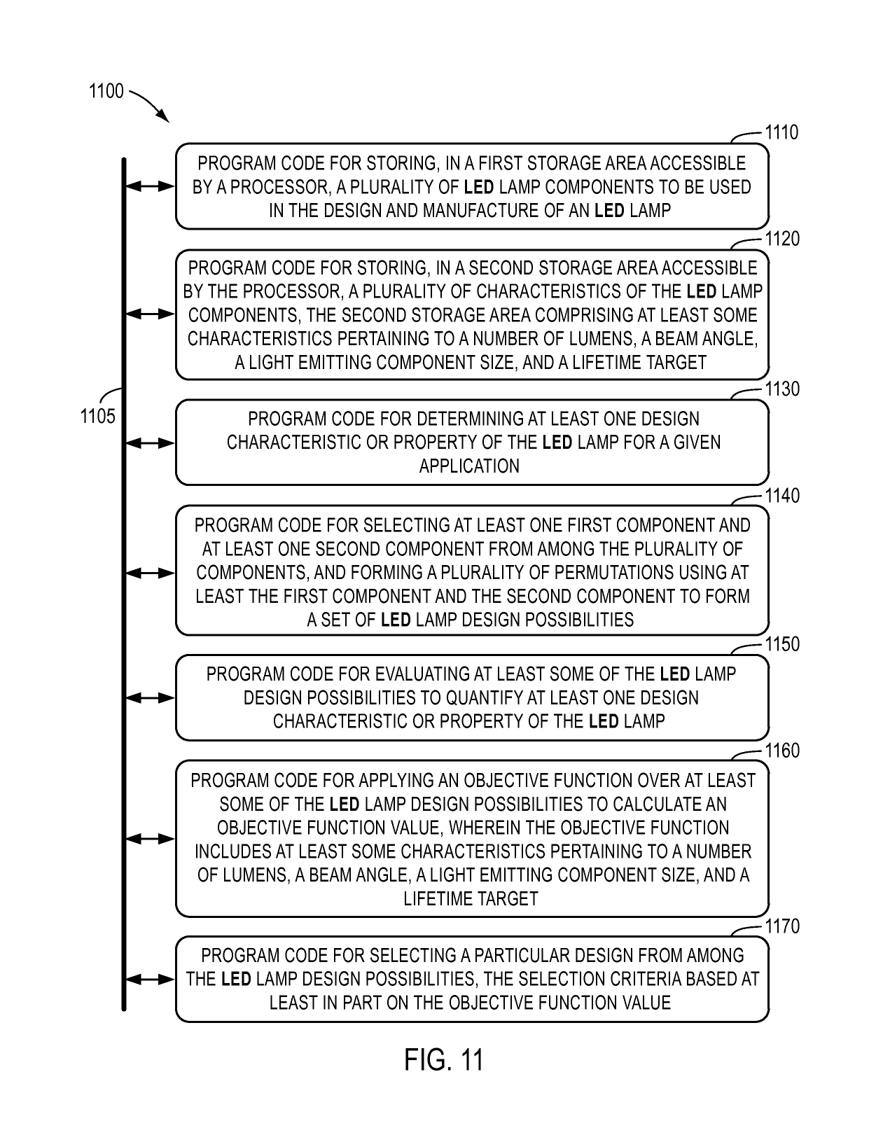

FIG. 11 depicts a set of method steps for building a light emitting diode (LED) lighting system using light engines and/or light modules. As an option, the present system 1100 may be implemented in the context of the architecture and functionality of the embodiments described herein. Of course, however, the system 1100 or any operation therein may be carried out in any desired environment.

As shown, system 1100 comprises at least one processor and at least one memory, the memory serving to store program instructions corresponding to the operations of the system. As shown, an operation can be implemented in whole or in part using program instructions accessible by a module. The modules are connected to a communication path 1105, and any operation can communicate with other operations over communication path 1105. The modules of the system can, individually or in combination, perform method operations within system 1100. Any operations performed within system 1100 may be performed in any order unless as may be specified in the claims. The embodiment of FIG. 11 implements a portion of a computer system, shown as system 1100, comprising a computer processor to execute a set of program code instructions and modules for accessing memory to hold program code instructions to perform: storing, in a first storage area accessible by a processor, a plurality of LED lamp components to be used in the design and manufacture of an LED lamp (see module 1110); storing, in a second storage area accessible by the processor, a plurality of characteristics of the LED lamp components, the second storage area comprising at least some characteristics pertaining to a number of lumens, a beam angle, a light emitting component size, and a lifetime target (see module 1120); determining at least one design characteristic or property of the LED lamp for a given application (see module 1130); selecting at least one first component and at least one second component from among the plurality of components, and forming a plurality of permutations using at least the first component and the second component to form a set of LED lamp design possibilities (see module 1140); evaluating at least some of the LED lamp design possibilities to quantify at least one design characteristic or property of the LED lamp (see module 1150); applying an objective function over at least some of the LED lamp design possibilities to calculate an objective function value, wherein the objective function includes at least some characteristics pertaining to a number of lumens, a beam angle, a light emitting component size, and a lifetime target (see module 1160); and selecting a particular design from among the LED lamp design possibilities, the selection criteria based at least in part on the objective function value (see module 1170). Some embodiments further comprise using the selected particular design for manufacture of an LED lamp or fixture. In some cases, operations for evaluating at least some of the LED lamp design possibilities to quantify at least one design characteristic or property of the LED lamp (see module 1150) can include a calculation or determination of a characteristic or property metric that is a characteristic quantity or property quantity based on the combination of two or more components. For example, a lifetime or use or reliability metric might be based on the selected combination of a particular number of lumens and a particular heatsink having particular thermal dissipation characteristics. The particular characteristic quantities or property quantities arising from interactions between combinations of two or more components can impact many other metrics. The aforementioned objective function can include terms involving not only the characteristic or property metrics that are based on the selection of individual components, but also, the objective function can include terms involving characteristic or property metrics that are a characteristic quantities or property quantities based on the combination of two or more components.

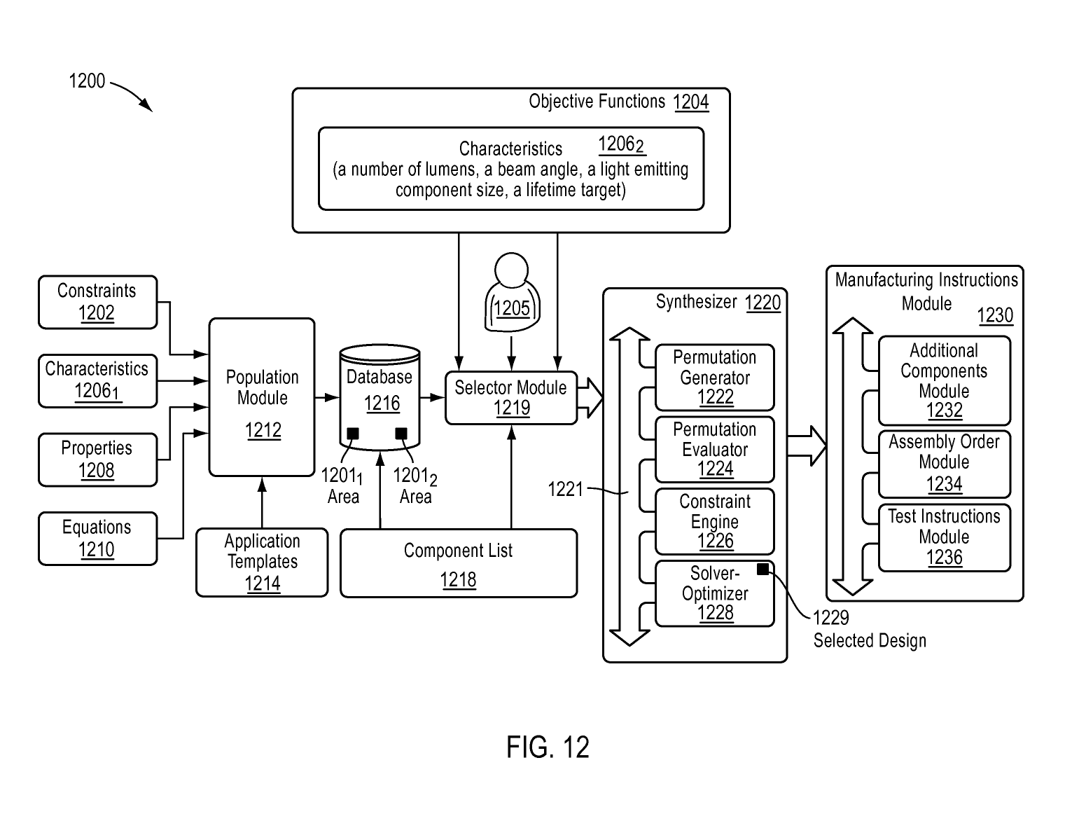

FIG. 12 depicts a block diagram of a system to perform certain method steps for building a light emitting diode (LED) lighting system using light engines and/or light modules. The shown a computing environment 1200 supports a computer-aided LED lamp design flow.

As shown, a user 1205 interacts with a design element selection tool (e.g., selector module 1219) and a synthesizer 1220. The synthesizer outputs aspects of a computer-aided design to a manufacturing instructions module 1230. The user can select from any number of components (e.g. selected from a component list 1218), which components are in turn described and stored in a database component (e.g., area 1201₁ for storing any number of LED lamp components, and area 1201₂ for storing characteristics of the LED lamp components).

Database 1216 can be populated using a component list 1218 (as shown) and/or using a population module 1212. The population module can analyze application templates 1214 and retrieve explicitly-identified or inferred aspects of the applications. For example, if the component list includes a light engine or light module, the application templates 1214 might include aspects of a particular compatibly-sized fixture. Further, an application template can call in applicable characteristics 1206₁, properties 1208, and constraints 1202. An application template might also call-in applicable optimization functions (e.g., objective functions 1204) and/or any equations (see equations 1210) that might support analysis of characteristics or properties, and/or might support application of an objective function over a particular LED lamp design and/or over a particular usage of a light engine or light module.

The synthesizer has access to the database 1216, and can receive a user selection of one or more components, or can receive a selection of one or more components (e.g., determined by selector module 1219). The selector module 1219 can determine design characteristics or properties of the LED lamp for a given application. The synthesizer proceeds to generate combinations of compatible components. A minimum set of components can be retrieved from an application template, and the compatibility of one component with another component can be determined using the characteristics 1206₁ and properties 1208. In some cases, combinations are formed of sets of components, and in other cases permutations are formed of sets of components that are used, assembled or manufactured in a particular order. Such an ordering (or absence of ordering) as is present in a permutation (or combination) can be initially defined or permitted or disallowed or constrained by corresponding properties 1208 or characteristics 1206.

A permutation generator 1222 is included in the shown synthesizer 1220, and the permutation generator can communicate with other operational units over path 1221. For example, the permutation generator can deliver a set of permutations to a permutation evaluator 1224 over path 1221. Further, the permutation evaluator 1224 can evaluate permutations in conjunction with a constraint engine 1226 over path 1221. In some cases, the total number of possible combinations or permutations is large, and a solver-optimizer 1228 might be employed to use an objective function to solve or optimize a solution in the presence of constraints (e.g., a solution being an optimal combination or permutation involving a light engine or light module and/or a selected set of characteristics 1206₂). In some cases, a solver-optimizer evaluates a subset of the possible combinations or permutations, and arrives at a selected design by iteratively selecting a next most important or most constrained component until the components needed for a given application are present in the LED lamp design.

A selected design 1229 can be passed to a manufacturing instructions module 1230, which in turn can use an additional components module 1232 to add additional components (e.g., optional components, geo-specific components, cosmetic components, etc.) and produce instructions for assembly (e.g., see assembly order module 1234) and instructions for testing (e.g., see test instructions module 1236). A computer program configures a database component (e.g., a database component configured to store optional components, geo-specific components, cosmetic components, etc.) and stores instructions for assembly.

As shown, the environment 1200 supports a design flow from a database of components and respective descriptions, through to synthesis and optimization, and on to generation of manufacturing and test instructions. Many flows are possible using the modules of the shown environment, and those skilled in the art will recognize that useful outputs can be formatted for review by a human user at any point in the flow. Those skilled in the art will also recognize that more design possibilities exist as the number of compatible components increases. Accordingly, the database is populated with a rich set of components and subcomponents, possibly including light engines and/or light modules.

Finally, it should be noted that there are alternative ways of implementing the embodiments disclosed herein. Accordingly, the present embodiments are to be considered as illustrative and not restrictive, and the claims are not to be limited to the details given herein, but may be modified within the scope and equivalents thereof.

What is claimed is:

1. A light emitting diode (LED) lighting system comprising:
at least one controller; and
at least one LED light source component electrically-coupled to the at least one controller, wherein,
the at least one LED light source component comprises at least one LED;
the at least one LED is operated at a junction temperature that is at least 15° C. higher than a temperature of the controller; and
the at least one LED light source component is disposed in a housing that is distally-located from the controller.

2. The LED lighting system of claim 1, wherein the at least one LED light source component is selected from one of a light engine and a light module.

3. The LED lighting system of claim 1, wherein constituents of the at least one LED lighting system are selected based at least in part on, a number of lumens, a beam angle, a light emitting component size, and a lifetime target.

4. The LED lighting system of claim 1, wherein the at least one controller comprises at least one electronic component and the temperature is measured at a periphery of the at least one electronic component.

5. The LED lighting system of claim 1, wherein the at least one controller is separated from the at least one LED by at least 1 centimeter.

6. The LED lighting system of claim 1, wherein the at least one controller comprises connections, wherein the connections are configured to send communications to the at least one LED light source component and to receive communications from the at least one LED light source component.

7. The LED lighting system of claim 1, wherein the at least one controller is configured to provide electrical power to the at least one LED light source component.

8. The LED lighting system of claim 1, wherein the at least one controller is configured to control illumination characteristics of the LED lighting system selected from intensity, direction, color, duration, rate of change, and a combination of any of the foregoing.

9. The LED lighting system of claim 1, wherein the at least one LED light source component is housed within an ANSI-standard form factor and the temperature of the controller is measured within the housing.

10. The LED lighting system of claim 1, wherein the at least one controller comprises circuitry configured to send communications to the at least one LED light source component and to receive communications from the at least one LED light source component.

11. The LED lighting system of claim 1, wherein the at least one controller is electrically coupled to the at least one LED light source component by a wireless communication.

12. The LED lighting system of claim 1, wherein the at least one LED light source component comprises a plurality of LED light source components wherein at least some of the plurality of LED light source components are electrically coupled to separate controllers.

13. A light emitting diode (LED) lighting system, comprising:
at least one controller; and
at least one LED light source component electrically-coupled to the at least one controller, wherein,
the at least one LED light source component comprises at least one LED; and
the controller is separated by a distance of at least 3 inches from the LED light source component.

14. The LED lighting system of claim 13, comprising a heatsink, wherein,
the heat sink comprises a cavity; and
the controller is physically disposed within the cavity of the heatsink.

15. The LED lighting system of claim 13, wherein one or more of the at least one LEDs is operatively coupled to a directional orientation device.
